(19) United States
(12) Patent Application Publication
(10) Pub. No.: US 2005/0024349 A1
(43) Pub. Date: Feb. 3, 2005

(54) Display apparatus and control method thereof

(75) Inventor: Young-ki Shon, Suwon-si (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd., Suwon-si (KR)

(21) Appl. No.: 10/863,508

(22) Filed: Jun. 9, 2004

(30) Foreign Application Priority Data
Jun. 9, 2003 (KR) 2003-36801
Oct. 28, 2003 (KR) 2003-75462

(51) Int. Cl. G09G 5/00

(52) U.S. Cl. 345/204

(57) ABSTRACT

A display apparatus including a rear cover provided with an air inflow hole and an air outflow hole spaced from each other, including: a ventilation fan circulating internal air of the display apparatus; a plurality of heat sinks which are thermal conductors of heat radiated from internal components of the display apparatus; a rotation position detector detecting a position of the display apparatus; and a controller operating the ventilation fan based on a detection signal of the rotation position detector when the display apparatus is installed at a predetermined angle relative to a normal installation position where a longitudinal direction of the display apparatus is perpendicular to a gravitational direction. The invention provides a display apparatus and a control method of the display apparatus operating the ventilation fan when the display apparatus is installed beyond a predetermined angle relative to the gravitational direction, and improving the internal heat circulation efficiency.

### CROSS-REFERENCE TO RELATED APPLICATIONS

This application claims the benefit of Korean Patent Application Nos. 2003-075462, filed Oct. 28, 2003, and 2003-0036801, filed Jun. 9, 2003, in the Korean Intellectual Property Office, the disclosures of which are incorporated herein by reference.

### BACKGROUND OF THE INVENTION

1. Field of the Invention

The present invention relates to a display apparatus and a control method thereof, and more particularly to a display apparatus and a control method thereof improving internal heat circulation efficiency by operating ventilation fans when a display apparatus is installed at a predetermined angle relative to a normal installation position where a longitudinal direction of the display apparatus is perpendicular to a gravitational direction.

2. Description of the Related Art

An internal temperature of a display apparatus rises due to heat radiated from various components according to an operation thereof. Accordingly, heat circulation is required to prevent the components from being damaged due to rising internal temperature of the display apparatus.

As shown in FIG. 8, a rear cover 31′ of a display apparatus is provided with air inflow/outflow holes 33′ exchanging heated air from inside the display apparatus with cold air from outside the display apparatus. Also, a heat sinks 39′ are provided inside the display apparatus along a gravitational direction when the display apparatus is installed in a way that the longitudinal direction of the display apparatus is perpendicular to the gravitational direction (referred to as ‘normal installation position’). Accordingly, if the internal temperature rises as heat is radiated from the internal components and warms up the air inside the display apparatus, the cold air outside flows into the display apparatus and the heated air inside flows out through the air inflow/outflow holes 33′. Also, ventilation fans 37′ can be provided on an upper side of the rear cover 31′ to suction the heated air from inside the display apparatus upward and ventilate the heated air outside of the display apparatus.

However, as shown in FIG. 9, when the display apparatus is installed in a position having a predetermined angle relative to a normal installation position (referred to as ‘rotated installation position’), natural heat circulation between upper and lower parts by convection hardly occurs. The heat sinks 39′ provided in a vertical direction of a display apparatus in the normal installation position interrupts air flow by convection in the display apparatus in the rotated installation position. Even when using the ventilation fans 37′, heat circulation throughout the display apparatus including a part where the ventilation fans 37′ are not provided, hardly occurs. This is because the ventilation fans 37′ are positioned on one of left and right sides of the display apparatus in the rotated installation position. Moreover, noise accompanying normal operation of the ventilation fans 37′ is disadvantageous.

### SUMMARY OF THE INVENTION

Accordingly, it is an aspect of the present invention to provide a display apparatus and a control method of the display apparatus improving internal heat circulation by operating a ventilation fans when the display apparatus is installed at a predetermined angle relative to a normal installation position where a longitudinal direction of the display apparatus is perpendicular to a gravitational direction.

Additional aspects and/or advantages of the invention will be set forth in part in the description which follows and, in part, will be obvious from the description, or may be learned by practice of the invention.

The foregoing and/or other aspects of the present invention are achieved by providing a display apparatus comprising a rear cover provided with air inflow holes and air outflow holes spaced from each other, including: ventilation fans circulating internal air of the display apparatus; a plurality of heat sinks which are thermal conductors of heat radiated from internal components of the display apparatus; a rotation position detector detecting a rotating position of the display apparatus; and a controller operating the ventilation fans on a basis of a detection signal of the rotation position detector when the display apparatus is installed at a predetermined angle relative to the normal installation position where a longitudinal direction of the display apparatus is perpendicular to a gravitational direction.

According to an aspect of the invention, the display apparatus further comprises a temperature detector detecting an internal temperature of the display apparatus, wherein the controller operates the ventilation fans on a basis of a detection signal of the temperature detector when the internal temperature of the display apparatus is greater than a predetermined temperature.

According to an aspect of the invention, the ventilation fans are provided between the plurality of heat sinks.

According to another aspect of the present invention, the above and/or other aspects may be also achieved by providing a control method of a display apparatus including a rear cover provided with air inflow holes and air outflow holes spaced from each other, including: detecting a position of the display apparatus; and operating the ventilation fans when the display apparatus is installed at a predetermined angle relative to a normal installation position where a longitudinal direction of the display apparatus is perpendicular to a gravitational direction.

According to an aspect of the invention, the control method of the display apparatus further includes: detecting an internal temperature of the display apparatus; and operating the ventilation fans if the internal temperature of the display apparatus is over a predetermined temperature, when the display apparatus is installed at a predetermined angle relative to the normal installation position where the longitudinal direction of the display apparatus is perpendicular to the gravitational direction.

### BRIEF DESCRIPTION OF THE DRAWINGS

The above and/or other aspects and advantages of the present invention will become apparent and more readily appreciated from the following description of the embodiments, taken in conjunction with the accompany drawings of which:

FIG. 1 illustrates various installation positions of a display apparatus according to an embodiment of the present invention;

FIG. 2 is a schematic view illustrating an inside of the display apparatus and a rear cover when the display apparatus of FIG. 1 is installed in a normal installation position;

FIG. 3 is a schematic view illustrating the inside of the display apparatus and the rear cover when the display apparatus of FIG. 1 is installed in a rotated installation position;

FIG. 4 is a control block diagram of the display apparatus of FIG. 1;

FIG. 5 is a circuit of a temperature detector of the display apparatus of FIG. 1;

FIG. 6 is a driving circuit of a ventilation fan of a controller of the display apparatus of FIG. 1;

FIG. 7 is a control flow chart of the display apparatus of FIG. 1;

FIG. 8 is a schematic view illustrating an inside of a conventional display apparatus and a rear cover when the conventional display apparatus is installed in a normal installation position;

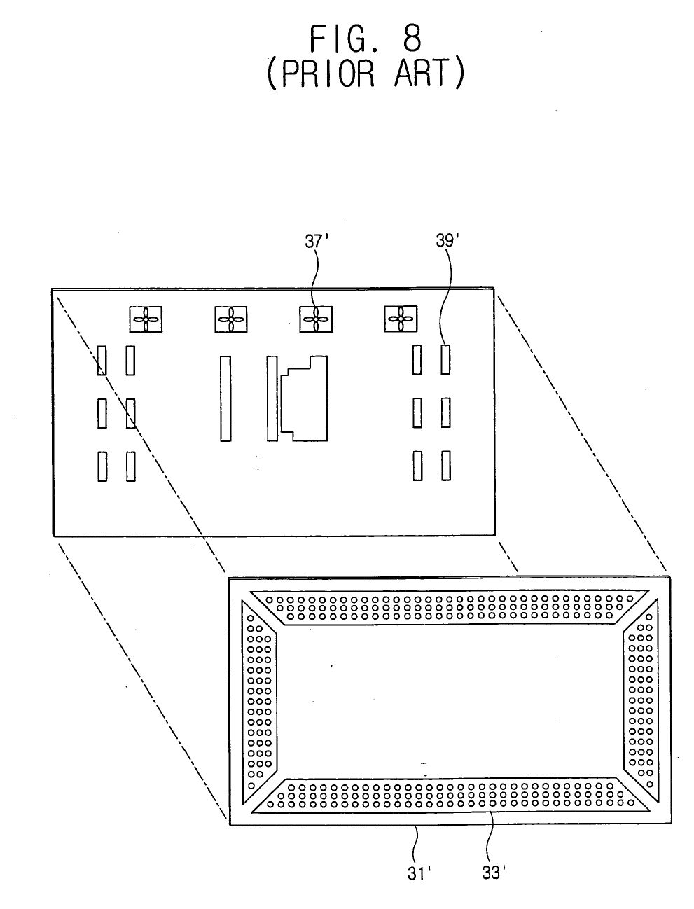

FIG. 9 is a schematic view illustrating the inside of the conventional display apparatus and the rear cover when the conventional display apparatus is installed in a rotated installation position.

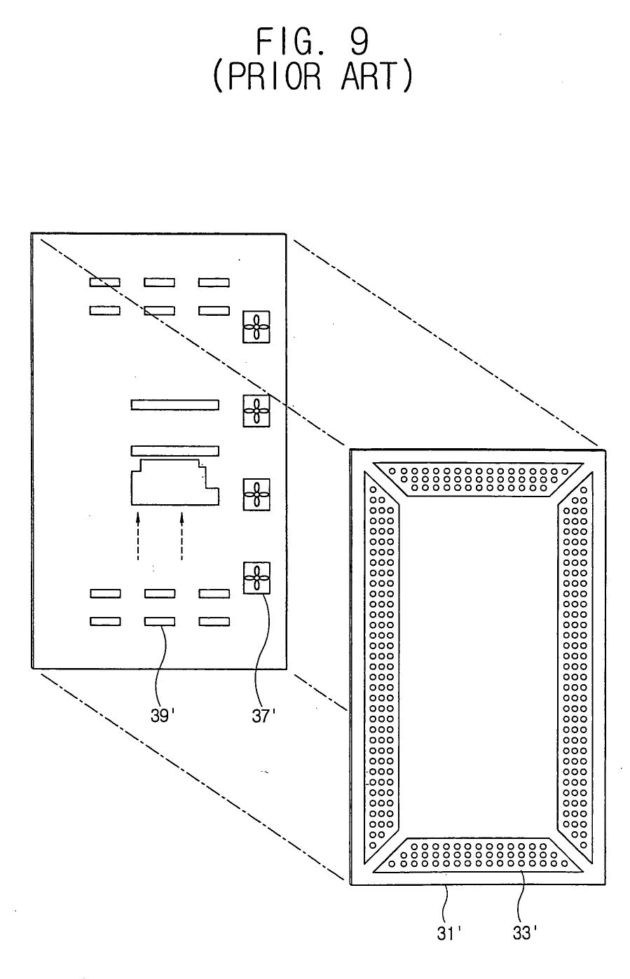

### DETAILED DESCRIPTION OF THE PREFERRED EMBODIMENTS

Reference will now be made in detail to the embodiments of the present invention, examples of which are illustrated in the accompanying drawings, wherein like reference numerals refer to like elements throughout. The embodiments are described below in order to explain the present invention by referring to the figures.

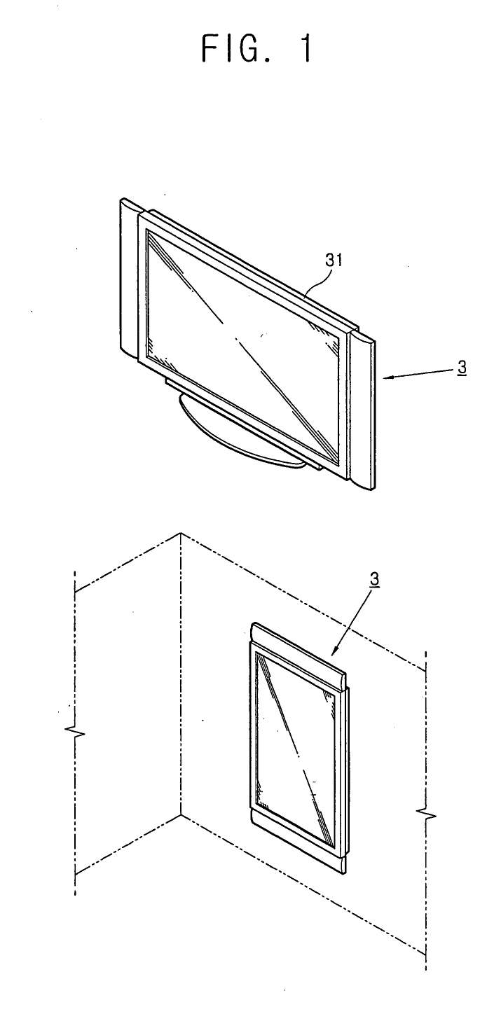

As shown in FIG. 1, a display apparatus 3 can be used in various positions. For general purposes, the display apparatus 3 is installed in a normal installation position where a longitudinal direction of the display apparatus 3 is perpendicular to a gravitational direction. However, for particular purposes such as displaying in an exhibition, the display apparatus 3 may be installed in a position where the longitudinal direction of the display apparatus 3 is at a predetermined angle relative to the normal installation position.

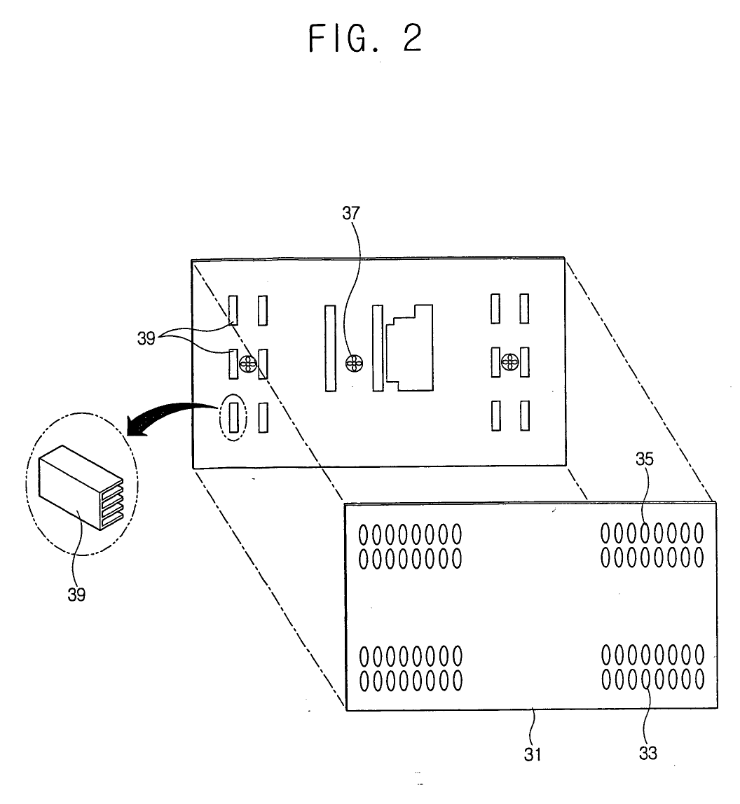

As shown in FIG. 2, the display apparatus 3 comprises a rear cover provided with air inflow holes 33 and air outflow holes 35 spaced from each other. An inside of the display apparatus 3 is provided with various components including ventilation fans 37 and heat sinks 39.

The heat sinks 39 are radiation plates or radiation fins made of aluminum or copper material absorbing and discharging heat radiated from components such as a chipset. Generally, when the display apparatus 3 is installed in a normal installation position where a longitudinal direction of the display apparatus 3 is perpendicular to a gravitational direction, the heat sinks 9 are provided along a vertical direction of the display apparatus 3. Herein, in a case that the display apparatus 3 is installed in the normal installation position, as the heat generated by the components of the display apparatus 3 is discharged into the air inside of the display apparatus 3 thus increasing an internal temperature, cold air outside the display apparatus 3 flows into the display apparatus 3 through the air inflow holes 33. Also, the heated air inside the display apparatus 3 is discharged out through the air outflow holes 35. Accordingly, the internal temperature of the display apparatus 3 is controlled by natural heat circulation according to convection.

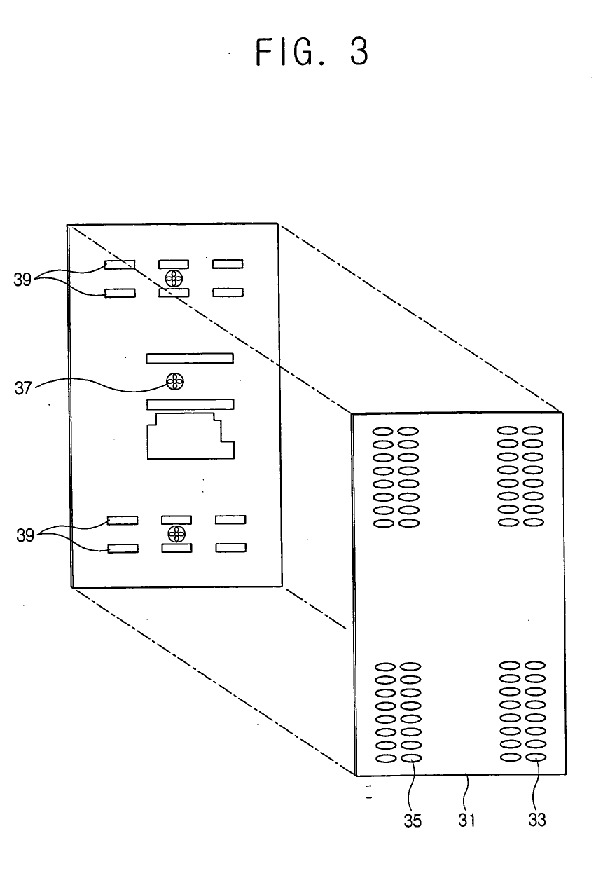

However, as shown in FIG. 3, when the display apparatus 3 is installed in the rotated installation position, for example, 90° in this instance, or at other possible rotation angles, where the display apparatus 3 is rotated at a predetermined angle relative to the normal installation position, the natural heat circulation in the vertical direction according to convection hardly occurs. This is because a path length of air convecting along the vertical direction is extended. Also, the heat sinks 39 provided along the vertical direction of the display apparatus 3 installed in the normal installation position work as a wall, interrupting air flow in the vertical direction of the display apparatus 3. Accordingly, natural heat circulation along the vertical direction is limited because an exchange of the heated air inside the display apparatus 3 and the cold air outside the display apparatus 3 cannot move smoothly through the air inflow holes 33 and the air outflow holes 35.

Herein, the ventilation fans 37 are used for artificial heat circulation. The ventilation fans 37 are provided on a proper position so that the heat radiated from the heat sinks 39 can be dissipated to the outside through the air outflow holes 35 and not confined within the heat sinks 39. As an example, the ventilation fans 37 are provided on the middle of the display apparatus 3 or on positions between the plurality of heat sinks 39, respectively. This way, the heat radiated from the components inside the display apparatus 3 can be dissipated to the outside by the artificial heat circulation created by the ventilation fans 37 without being confined within the heat sinks 39. Herein, the number of the ventilation fans 37 increases accordingly as the size of the display apparatus 3 increases.

The ventilation fans 37 operate only when the display apparatus 3 is installed in the rotated installation position. In other words, when the display apparatus 3 is installed in the normal installation position, natural heat circulation occurs through the heat sinks 39 provided along the vertical direction of the display apparatus 3, the air inflow holes 33, and the air outflow holes 35. Further when the display apparatus 3 is installed in the rotated installation position, the artificial heat circulation occurs through the ventilation fans 37. Accordingly, as the operating duration of the ventilation fans 37 decreases, the time that the user is exposed to the noise of the ventilation fans 37 decreases too.

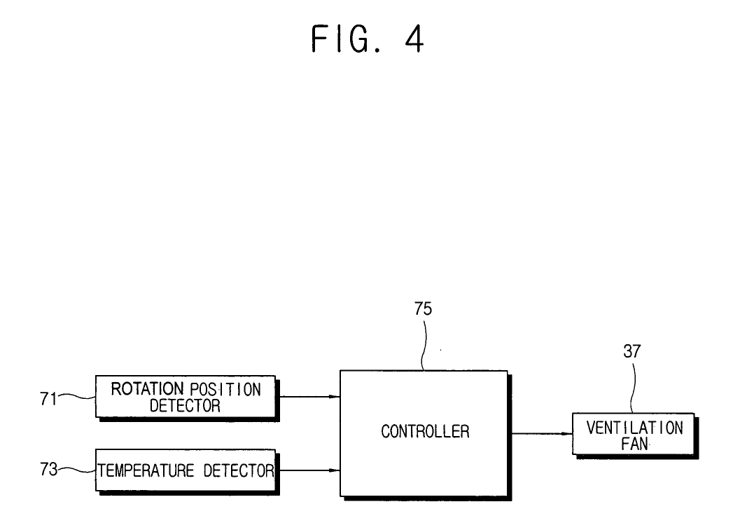

As shown in FIG. 4, the display apparatus 3 according to the embodiment of the present invention further comprises a rotation position detector 71, a temperature detector 73, and a controller 75.

The temperature detector 73 detects an internal temperature of the display apparatus 3 and transfers the internal temperature to the controller 75.

The rotation position detector 71 detects a position of the display apparatus 3 and transfers the position of the display apparatus 3 to the controller 75.

For example, the rotation position detector 71 comprises a pendulum provided along a gravitational direction to function as a switch and signal output pins provided in a transverse direction to generate a signal of high level or low level. If the rotation position detector 71 is tilted toward the left or right side of the gravitational direction past a predetermined angle, the pendulum contacts a signal output pin so that the signal output pin is connected to a grounding terminal of the rotation position detector 71. Herein, the rotation position detector 71 outputs a low level signal. If the display apparatus 3 returns to a normal installation position, the rotation position detector 71 outputs a high level signal as the signal output pin is detached from the grounding terminal.

Also, when the controller 75 receives a signal from the rotation position detector 71 notifying that the display apparatus 3 is in the rotated installation position, the controller 75 operates the ventilation fans 37 if the temperature detector 73 detects that the internal temperature of an internal space exceeds a predetermined temperature.

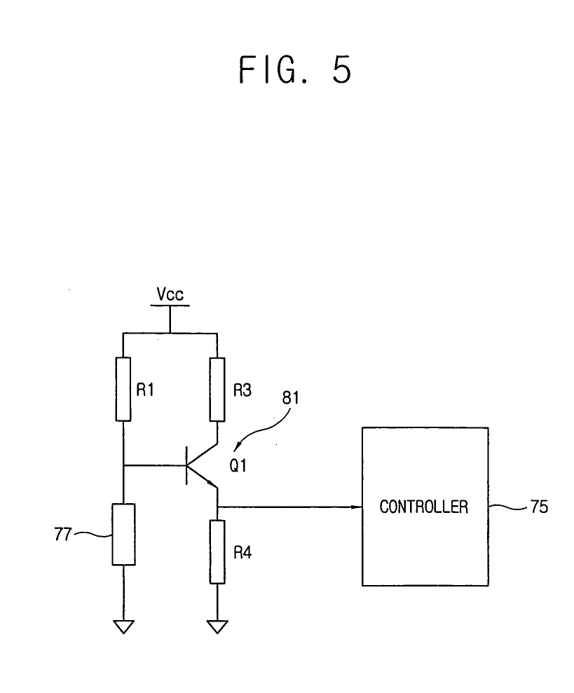

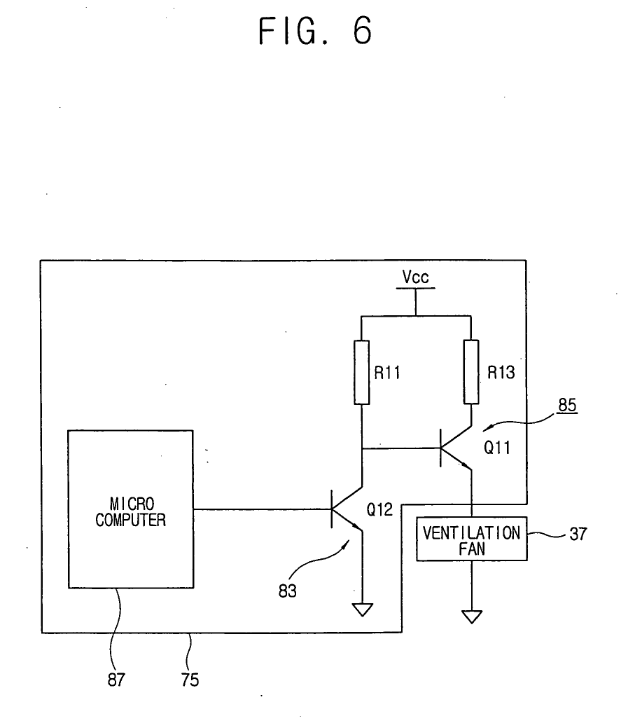

As shown in FIGS. 5 and 6, the temperature detector 73 comprises a thermal resistor 77 and a first bi-junction transistor (BJT) 81. As the internal temperature of the display apparatus 3 increases, a resistance of the thermal resistor 77 increases. Accordingly, when the internal temperature of the display apparatus 3 is greater than a predetermined temperature, a voltage on a base terminal of the first BJT 81 increases operating the first BJT 81. Then, the first BJT 81 outputs a high level signal to the controller 75.

The controller 75 comprises a micro-computer 87, a second BJT 83, and a third BJT 85. When the micro-computer 87 receives a signal from the rotation position detector 71 notifying that the display apparatus 3 is in the rotated installation position, and a signal from the temperature detector 73 notifying that the internal temperature of the internal space is greater than the predetermined temperature, the micro-computer 87 outputs the high level signal to the second BJT 83. Subsequently, as the second BJT 83 operates by the high level signal, the third BJT 85 operates with a base terminal of the third BJT 85 applied with the voltage. The ventilation fans 37 operate according to the operation of the third BJT 85.

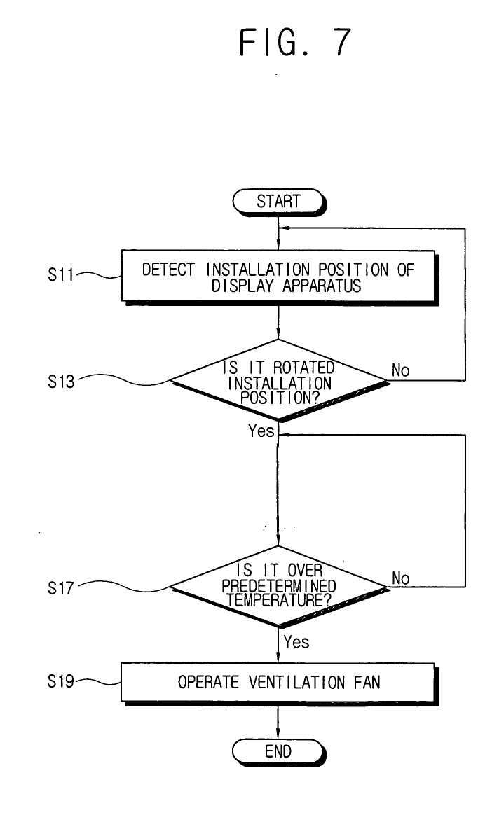

Hereinbelow, a control flow of the embodiment of the present invention will be described in reference with FIG. 7.

At operation S11, the rotation position detector 71 detects an installation status of the display apparatus 3. If the rotation position detector 71 detects that the display apparatus 3 is in the rotated installation position at operation S13, the rotation position detector 71 transfers a predetermined signal to the controller 75. The rotation position detector 71 includes the pendulum provided along the gravitational direction functioning as a switch and the signal output pins provided along the transverse direction generating high or low level signals. For example, if the rotation position detector 71 is tilted at a predetermined angle relative to the gravitational direction, the signal output pin provided along the tilted direction contacts the pendulum and gets connected to the grounding terminal of the rotation position detector 71 to output the low level signal.

The temperature detector 73 detects the internal temperature of the display apparatus 3 at operation S17, and transfers a predetermined signal to the controller 75 when the internal temperature is greater than a predetermined temperature.

At operation S19, the controller 75 turns on the ventilation fans 37 when the controller 75 receives a signal from the rotation position detector 71 notifying that the display apparatus 3 is in the rotated installation position and a signal from the temperature detector 73 notifying that the internal temperature of the display apparatus 3 is over the predetermined temperature.

Accordingly, when the display apparatus 3 is installed in the normal installation position, natural heat circulation occurs with the aid of the air inflow holes 33 and the air outflow holes 35. Meanwhile, when the display apparatus 3 is installed in the rotated installation position, artificial heat circulation is created by the ventilation fans 37. Accordingly, a time duration during which the user is exposed to the noise of the ventilation fans 37 decreases. Also, since the ventilation fans 37 are provided on the middle of the display apparatus 3 and on positions between the plurality of heat sinks 39, the heat radiated from the components inside the display apparatus 3 is discharged out by the artificial heat circulation created by the ventilation fans 37, and not confined within the heat sinks 39. Accordingly, overall heat circulation efficiency inside the display apparatus 3 is improved.

As described above, the embodiment of the present invention provides a display apparatus and a control method of the display apparatus operating the ventilation fans when the display apparatus is installed beyond a predetermined angle relative to the gravitational direction, and improving the internal heat circulation efficiency.

The aforementioned method of controlling air inflow in a display apparatus may be embodied as a computer program that can be run by a computer, which can be a general or special purpose computer. Thus, it is understood that the display apparatus can be such a computer. Computer programmers in the art can easily reason codes and code segments, which constitute the computer program. The program is stored in a computer readable medium readable by the computer. When the program is read and run by a computer, the method of controlling air inflow in the display apparatus is performed. Here, the computer-readable medium may be a magnetic recording medium, an optical recording medium, a carrier wave, firmware, or other recordable media.

Although a few embodiments of the present invention have been shown and described, it will be appreciated by those skilled in the art that changes may be made in these embodiments without departing from the principles and spirit of the invention, the scope of which is defined in the appended claims and their equivalents.

1. A display apparatus comprising a rear cover provided with an air inflow hole and an air outflow hole spaced from each other, comprising:
a ventilation fan circulating internal air from the display apparatus;
a plurality of heat sinks which are thermal conductors of heat radiated from internal components of the display apparatus;
a rotation position detector detecting a rotation position of the display apparatus; and
a controller operating the ventilation fan on a basis of a detection signal of the rotation position detector when the display apparatus is installed at a predetermined angle relative to a normal installation position where a longitudinal direction of the display apparatus is perpendicular to a gravitational direction.

2. The display apparatus according to claim 1, further comprising a temperature detector detecting an internal temperature of the display apparatus, wherein the controller operates the ventilation fan on a basis of a detection signal of the temperature detector when the internal temperature of the display apparatus is over a predetermined temperature.

3. The display apparatus according to claim 1, wherein the ventilation fan is provided between the plurality of heat sinks.

4. A control method of a display apparatus comprising a rear cover provided with an air inflow hole and an air outflow hole spaced from each other, comprising
detecting a position of the display apparatus; and
operating a ventilation fan when the display apparatus is installed beyond a predetermined angle relative to a normal installation position where a longitudinal direction of the display apparatus is perpendicular to a gravitational direction.

5. The control method of the display apparatus according to claim 4, further comprising:
detecting an internal temperature of the display apparatus; and
operating the ventilation fan if the internal temperature of the display apparatus is beyond a predetermined temperature, when the display apparatus is installed beyond a predetermined angle relative to the normal installation position where the longitudinal direction of the display apparatus is perpendicular to the gravitational direction.

6. A display apparatus comprising:
a ventilation fan circulating internal air created by internal components of the display apparatus;
a plurality of heat sinks radiating heat from the internal components of the display apparatus;
a rotation position detector detecting a rotation position of the display apparatus; and
a controller controlling the ventilation fan based on the detected position of the display apparatus.

7. The display apparatus according to claim 6, wherein the controller activates the ventilation fan if the display apparatus is installed at a position other than a normal installation position.

8. The display apparatus according to claim 6, wherein at the normal installation position, the display apparatus is installed in a longitudinal direction perpendicular to a gravitational direction.

9. The display apparatus according to claim 6, further comprising a temperature detector detecting an internal temperature of the display apparatus, wherein the controller controls the ventilation fan based on the detected internal temperature of the display apparatus.

10. The display apparatus according to claim 9, wherein the ventilation fan is activated if the detected internal temperature of the display apparatus is greater than a predetermined internal temperature.

11. The display apparatus according to claim 6, wherein the heat sinks are radiation plates or radiation fins made of aluminum or copper material.

12. The display apparatus according to claim 6, wherein the rotation position detector comprises a pendulum, provided along a gravitational direction functioning as a switch, and signal output pins, provided in a transverse direction generating a signal of high or low level.

13. The display apparatus according to claim 12, wherein if the pendulum is tilted toward a left or right side of the gravitational direction, the pendulum contacts the signal output pins so that the signal output pins are connected to a grounding terminal.

14. The display apparatus according to claim 9, wherein the temperature detector comprises a thermal resistor and a first bi-junction transistor, wherein as the internal temperature of the display apparatus increases, a resistance of the thermal resistor increases.

15. The display apparatus according to claim 6, wherein the ventilation fan is provided in a middle portion of the display apparatus and on positions between the plurality of heat sinks.

16. The display apparatus according to claim 14, wherein when the internal temperature of the display apparatus is greater than a predetermined temperature, a voltage on a base terminal of the first bi-junction transistor increases operating the first bi-junction transistor.

17. The display apparatus according to claim 6, wherein the controller comprises a microcomputer, a second bi-junction transistor, and a third bi-junction transistor.

18. The display apparatus according to claim 17, wherein when the microcomputer receives a signal from the rotation position detector notifying that the display apparatus is in a rotated installation position and a signal from a temperature detector notifying that an internal temperature of the display apparatus is greater than a predetermined temperature, the micro-computer outputs a high level signal to the second bi-junction transistor.

19. A method of controlling air flow in a display apparatus, the method comprising:
detecting a position of the display apparatus; and
operating a ventilation fan if the display apparatus is installed beyond a predetermined angle with respect to a normal installation position of the display apparatus.

20. The control method according to claim 19, further comprising:
detecting an internal temperature of the display apparatus; and
operating the ventilation fan if the internal temperature of the display apparatus is beyond a predetermined temperature.

21. A method of controlling air flow in a display apparatus, the method comprising:
detecting a position and an internal temperature of the display apparatus; and
operating a ventilation fan if the display apparatus is installed beyond a predetermined angle with respect to a normal installation position of the display apparatus and if the internal temperature of the display apparatus is beyond a predetermined temperature.

22. A computer readable medium encoded with processing instructions for performing a method of controlling air flow in a display apparatus, the method comprising:
detecting a position of the display apparatus; and
operating a ventilation fan when the display apparatus is installed beyond a predetermined angle relative to a normal installation position where a longitudinal direction of the display apparatus is perpendicular to a gravitational direction.

23. The computer readable medium according to claim 22, wherein the method further comprises:
detecting an internal temperature of the display apparatus; and
operating the ventilation fan if the internal temperature of the display apparatus is beyond a predetermined temperature.

24. The computer readable medium according to claim 22, wherein the computer-readable medium is one of a magnetic recording medium, an optical recording medium, a carrier wave, or firmware.
